(19) United States
(12) Patent Application Publication
(10) Pub. No.: US 2022/0387253 A1
(43) Pub. Date: Dec. 8, 2022

(54) INTELLIGENT START AND STOP MASSAGER

(71) Applicant: Shenzhen Alltokee Technology Co., Ltd, Shenzhen (CN)

(72) Inventor: Minyi Huang, Lianping (CN)

(73) Assignee: Shenzhen Alltokee Technology Co., Ltd, Shenzhen (CN)

(21) Appl. No.: 17/889,466

(22) Filed: Aug. 17, 2022

(51) Int. Cl. A61H 23/02; A61H 23/06

(52) U.S. Cl. CPC A61H 23/0254; A61H 23/06; A61H 2201/1207

(57) ABSTRACT

An intelligent start and stop massager is provided, which includes a first shell, a connecting spring, and a second shell; the first shell is connected to the second shell through the connecting spring; a vibration motor is arranged in the first shell; the vibration motor is in driving connection with a deflection member; a battery, a main control board and a touch switch are arranged in the second shell; the main control board is in conduction connection with the vibration motor, the battery and the touch switch; a first rubber layer is wrapped on an outer side of the first shell; and a second rubber layer is wrapped on an outer side of the second shell.

### TECHNICAL FIELD

The present disclosure relates to the field of massagers, in particular to an intelligent start and stop massager.

### BACKGROUND

The statements here only provide the background information related to the present disclosure, and do not necessarily constitute the prior art.

With the development of intelligent science and technology and people's attention to health, more and more people will use massagers to relax the body. Traditional massagers are all turned on and turned off through a button switch. In this way, it is inconvenient for some users to use the massagers.

Therefore, it is necessary to study a new technical solution to solve the above problems.

### SUMMARY

In order to solve the defects and shortcomings in the above-mentioned prior art, the present disclosure provides an intelligent start and stop massager. By designing an intelligent start and stop massager, the massager can be automatically turned on when a user holds the massager; and the massager can be automatically turned off when the user releases the massager. The use convenience of the massager is further improved.

In order to achieve the above-mentioned objective, the present disclosure adopts the following technical solution: An intelligent start and stop massager includes a first shell, a connecting spring, and a second shell; a lower end of the first shell is connected to an upper end of the second shell through the connecting spring;
a vibration motor is arranged in the first shell; the vibration motor is in driving connection with a deflection member; a battery, a main control board and a touch switch are arranged in the second shell; the main control board is in conduction connection with the vibration motor, the battery and the touch switch;
a first rubber layer is wrapped on an outer side of the first shell; and a second rubber layer is wrapped on an outer side of the second shell.

In some embodiments, a movement clearance is kept between the lower end of the first shell and the upper end of the second shell.

In some embodiments, the first shell is provided with an upper end cover, and the upper end cover is light-transmittable;
a lamp panel which emits light towards the upper end cover is arranged in the first shell; and the main control board is in control connection with the lamp panel.

In some embodiments, the lamp panel is arranged on an upper side of the vibration motor.

In some embodiments, the touch switch is a touch sensor chip which is mounted on an inner side wall of the second shell.

In some embodiments, the touch sensor chip is a capacitive touch sensor chip or a resistive touch sensor chip.

In some embodiments, the touch sensor chip is a copper foil or an aluminum foil.

In some embodiments, a first fastening bulge is arranged on the second rubber layer; a first fastening slot matched with the first fastening bulge is formed in the first rubber layer; and during assembling, the first fastening bulge is located in the first fastening slot.

In some embodiments, a second fastening slot is arranged on the outer side of the first shell; and a second fastening bulge matched with the second fastening slot is arranged on the first rubber layer.

In some embodiments, the main control board is further in conduction connection with a charging contact used for charging the battery; and the charging contact is arranged on a lower side surface of the second shell.

In some embodiments, the intelligent start and stop massager further includes a charging base; the charging base is provided with a charging recess with an upward opening; the charging recess is matched with a lower side of the second rubber layer; and a bottom of the charging recess is provided with a charging flicking needle matched with the charging contact.

In some embodiments, the first shell and the second shell are both made of plastic.

In some embodiments, a friction indent is provided on an outer side surface of the second rubber layer, and the friction indent extends along an up-down direction.

In some embodiments, the main control board is arranged on a lower side of the battery, and the touch switch is arranged on a peripheral side of the battery.

In some embodiments, an upper end of the second rubber layer extends to and wraps a lower side of the first shell.

Compared with the prior art, the present disclosure has obvious advantages and beneficial effects. Specifically, it can be known from the above-mentioned technical solutions that mainly by designing an intelligent start and stop massager, the massager can be automatically turned on when a user holds it; and the massager can be automatically turned off when the user releases it. The use convenience of the massager is further improved. Meanwhile, the first shell and the second shell are connected using the connecting spring, so that the first shell can move relative to the second shell, and a massage head can deform to be more in line with the human physiological curve; and the use comfort of the massager is improved.

In order to describe the structural features and effects of the present disclosure more clearly, the present disclosure is described in detail below in combination with the accompanying drawings and specific embodiments.

### BRIEF DESCRIPTION OF THE DRAWINGS

FIG. 1 is a schematic three-dimensional diagram of Embodiment I of the present disclosure;

FIG. 2 is an exploded diagram of Embodiment I of the present disclosure;

FIG. 3 is a schematic sectional diagram of Embodiment I of the present disclosure;

FIG. 4 is a partially enlarged diagram of a portion A in FIG. 3;

FIG. 5 is a partially enlarged diagram of a portion B in FIG. 3;

FIG. 6 is another schematic sectional diagram of Embodiment I of the present disclosure (a first rubber layer and a second rubber layer are hidden);

FIG. 7 is an exploded diagram of Embodiment II of the present disclosure;

FIG. 8 is a schematic sectional diagram of Embodiment II of the present disclosure;

FIG. 9 is a sectional diagram of FIG. 8.

Reference signs in the drawings:

10: first shell; 11: vibration motor; 111: deflection member; 12: upper end cover; 13: lamp panel; 14: first fastening slot; 15: second fastening slot; 20: second shell; 21: battery; 22: main control board; 221: charging contact; 23: touch switch; 24: third fastening bulge; 30: connecting spring; 31: movement clearance; 40: first rubber layer; 41: second fastening bulge; 50: second rubber layer; 51: friction indent; 52: first fastening bulge; 53: third fastening slot; 60: charging base; 61: charging recess; and 62: charging flicking needle.

### DETAILED DESCRIPTION OF THE EMBODIMENTS

The technical solutions in the embodiments of the present disclosure will be clearly and completely described below in conjunction with the accompanying drawings. Apparently, the described embodiments are only preferred embodiments of the present disclosure.

It should be noted that when an element is referred to as being “fixed” to another element, it can be directly on the other element or an intermediate element may also exist. When an element is considered to be “connected” to another element, it can be directly connected to the other element or an intermediate element may be present at the same time. The terms “perpendicular”, “horizontal”, “left”, “right” and similar expressions used herein are for illustrative purposes only, and are not meant to be the only implementation modes.

Unless otherwise defined, all technical and scientific terms used herein are the same as meanings of general understandings of those skilled in the art of the present disclosure. The terms used in the description of the present disclosure herein are merely to describe the specific implementation modes, not intended to limit the present disclosure. The term “and/or” used herein includes any and all combinations of one or more related listed items.

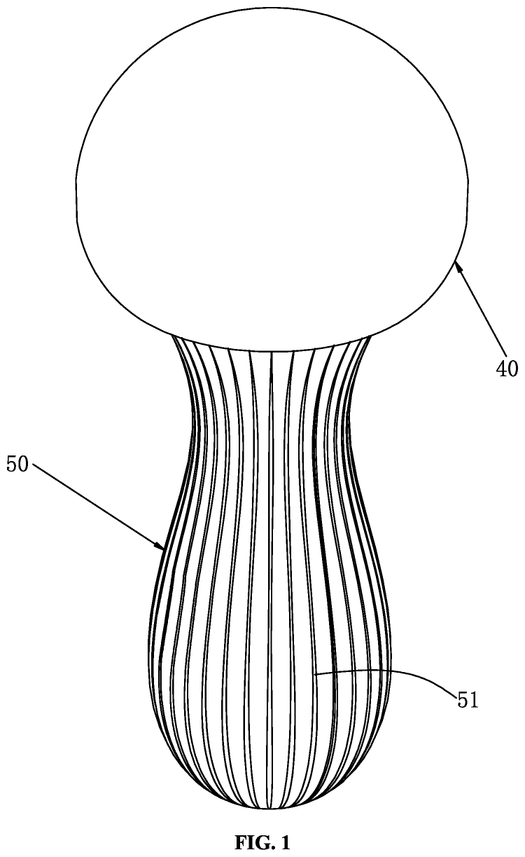

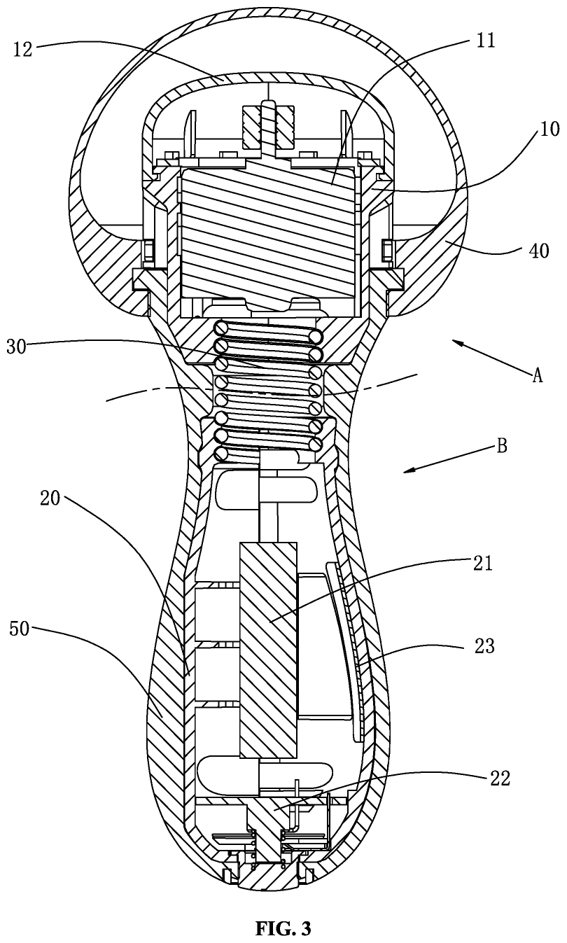

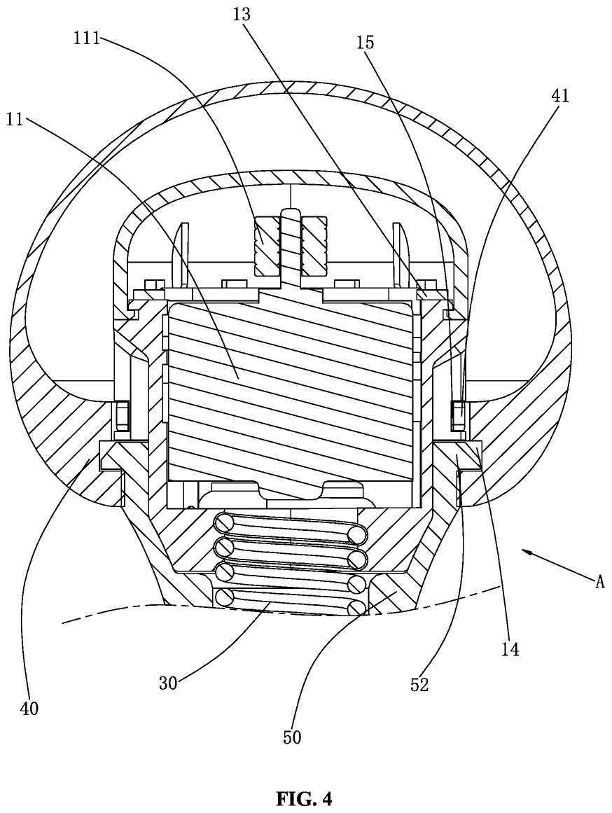

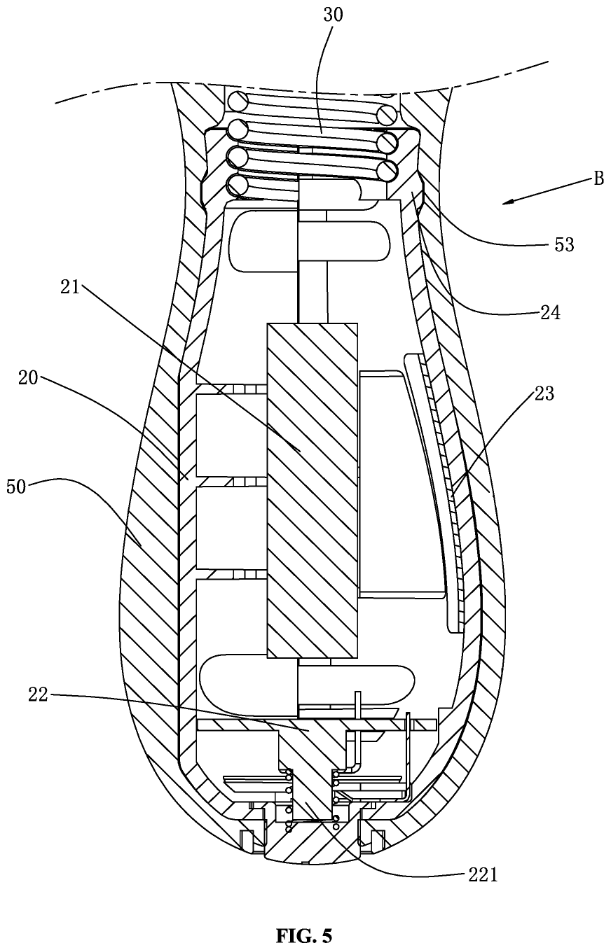

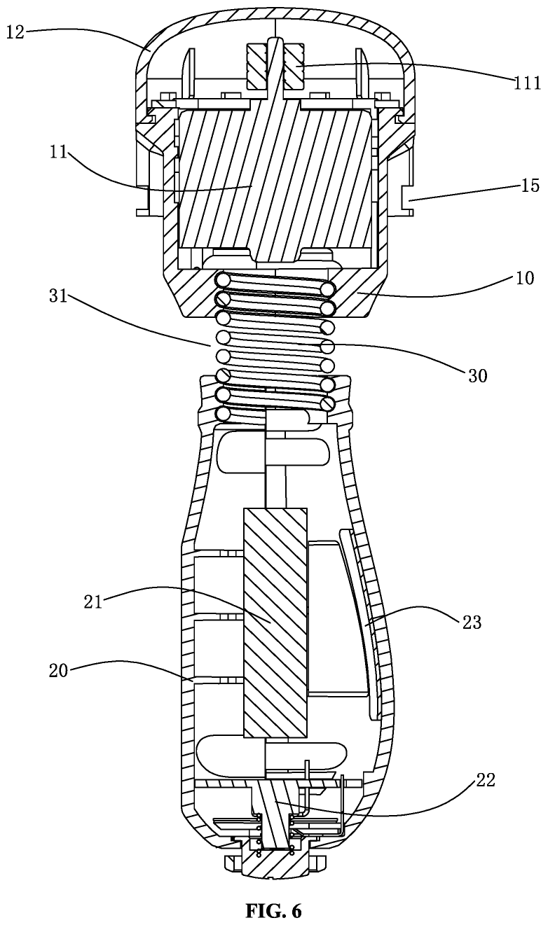

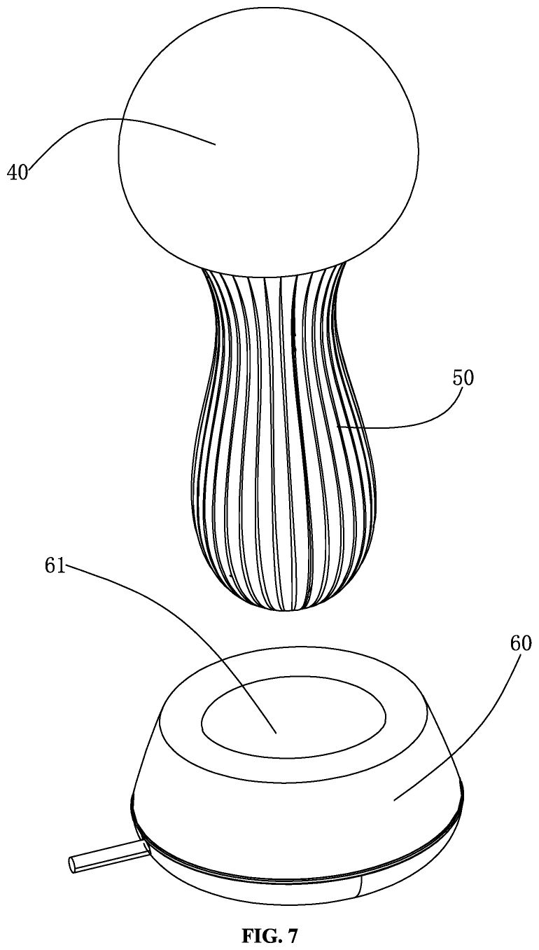

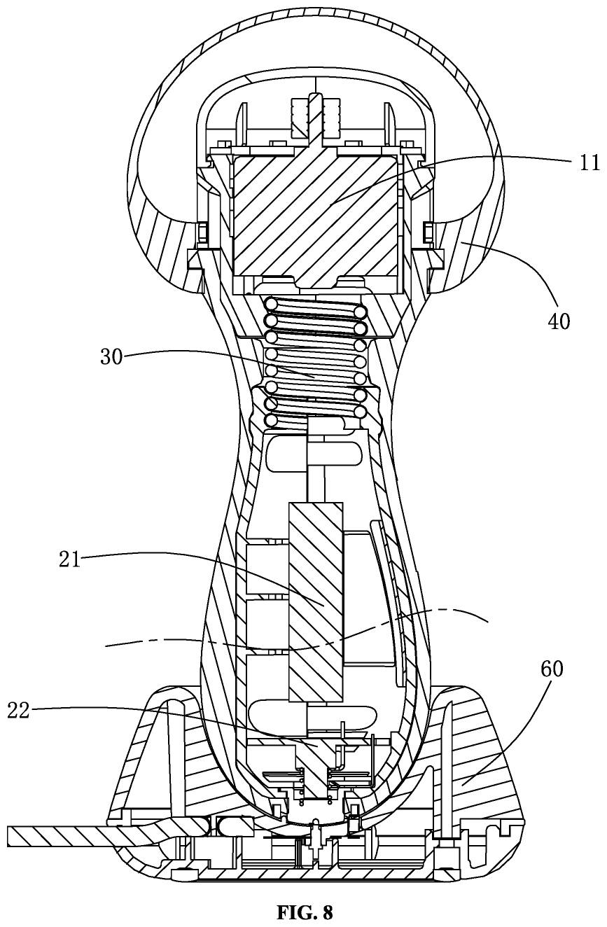

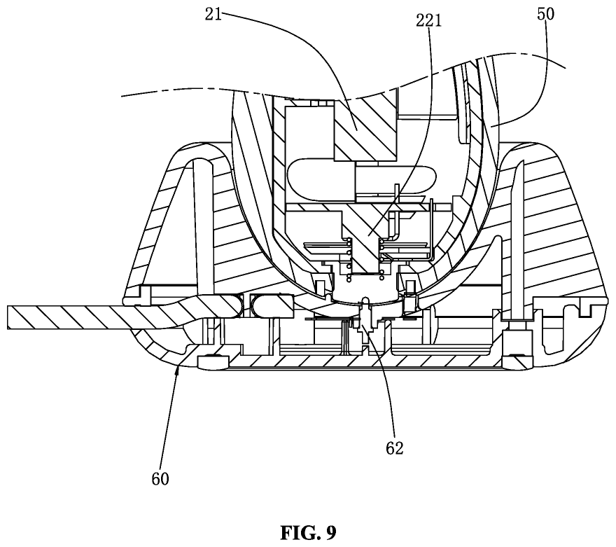

Referring to FIG. 1 to FIG. 9, an intelligent start and stop massager in the embodiment of the present disclosure includes a first shell 10, a connecting spring 30, and a second shell 20; and a lower end of the first shell 10 is connected to an upper end of the second shell 20 through the connecting spring 30.

A vibration motor 11 is arranged in the first shell 10; the vibration motor 11 is in driving connection with a deflection member 111; a battery 21, a main control board 22 and a touch switch 23 are arranged in the second shell 20; and the main control board 22 is in conduction connection with the vibration motor 11, the battery 21 and the touch switch 23.

A first rubber layer 40 is wrapped on an outer side of the first shell 10; and a second rubber layer 50 is wrapped on an outer side of the second shell 20. In this way, since the touch switch 23 is arranged in the second shell 20, when a human hand touches the touch switch 23, the touch switch 23 transmits a triggering signal to the main control board 22, and the main control board 22 correspondingly controls the vibration motor 11 to work, thus achieving an effect of intelligently starting and stopping the massager.

Specifically, the touch switch 23 is a touch sensor chip which is mounted on an inner side wall of the second shell 20. The touch sensor chip may be either a capacitive touch sensor chip or a resistive touch sensor chip. The rough working principle is as follows: When a human hand gets close to the touch sensor chip, a capacitance or resistance of the touch sensor chip changes, and an instruction is transmitted to the main control board 22 (the main control board 22 is provided with a corresponding integrated circuit (IC) chip); and the main control board 22 controls a switching circuit to achieve the purpose of turning on or turning off the vibration motor 11. In actual applications, the touch sensor chip may be either a copper foil or an aluminum foil. Of course, it may also be other conductive materials (media).

Further, the first shell 10 and the first rubber layer 40 form a massage head of the massager, and the second shell 20 and the second rubber layer 50 form a handle portion of the massager. An upper end of the massage head is hemispherical, and the handle portion is rodlike and waisted. Therefore, the massager has the advantage of convenience in holding and use. Furthermore, an upper end of the second rubber layer 50 extends to and wraps a lower side (a lower side portion) of the first shell 10, so that the wrapping effect of the first rubber layer 40 and the second rubber layer 50 on the first shell 10, the connecting spring 30 and the second shell 20 is better, and the wrapping stability is higher.

Preferably, several friction grooves 51 used for increasing friction are also provided on an outer side surface of the second rubber layer 50, and the friction grooves 51 all extend along an up-down direction.

Further, a movement clearance 31 is kept between the lower end of the first shell 10 and the upper end of the second shell 20. Thus, the first shell 10 can appropriately swing and deform relative to the second shell 20, which further improves the experience of the massager.

Further, the first shell 10 is provided with an upper end cover 12, and the upper end cover 12 is light-transmittable.

A lamp panel 13 which emits light towards the upper end cover 12 is arranged in the first shell 10; and the main control board 22 is in control connection with the lamp panel 13. Specifically, the lamp panel 13 is arranged on an upper side of the vibration motor 11, and Light Emitting Diode (LED) lamp beads for emitting light are provided on the lamp panel 13.

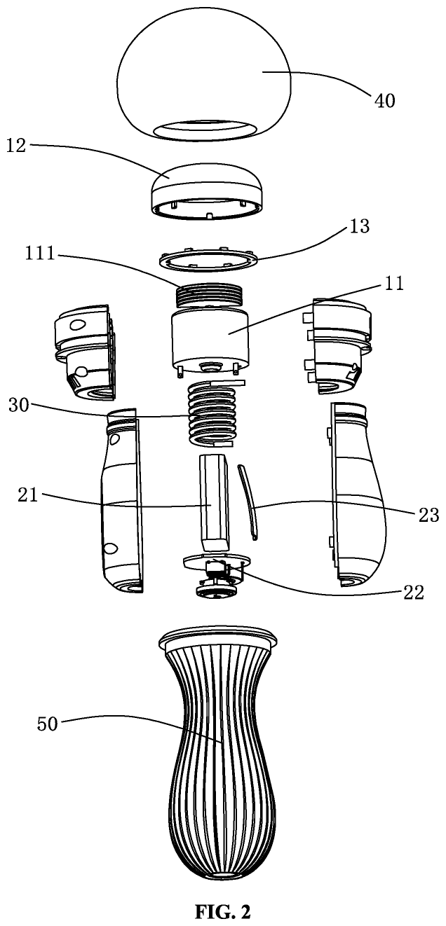

Further, the first shell 10 and the second shell 20 are preferably made of plastic. Specifically, referring to FIG. 2, the first shell 10 includes a first left shell, a first right shell and the foregoing upper end cover which are encircled to form a first mounting cavity used for mounting the vibration motor 11 and the lamp panel 13; and the second shell includes a second left shell and a second right shell which are encircled to form a second mounting cavity used for mounting the battery 21, the main control board 22 and the touch switch 23.

Preferably, the main control board 22 is arranged on a lower side of the battery 21, and the touch switch 23 is arranged on a peripheral side of the battery 21. The battery 21 is a battery cell with an electricity storage function.

Preferably, a first fastening bulge 52 is arranged on the second rubber layer 50; and a first fastening slot 14 matched with the first fastening bulge 52 is formed in the first rubber layer 40. During assembling, the first fastening bulge 52 is located in the first fastening slot 14. In this way, assembling of the first rubber layer 40 and the second rubber layer 50 is facilitated.

Further, a second fastening slot 15 is arranged on the outer side of the first shell 10; and a second fastening bulge 41 matched with the second fastening slot 15 is arranged on the first rubber layer 40. In this way, the wrapping stability between the first rubber layer 40 and the first shell 10 is further guaranteed. A third fastening bulge 24 is arranged on the second shell 20, and the second rubber layer is provided with a third fastening slot 53 matched with the third fastening bulge 24. In this way, it is favorable for more conveniently sleeving the second rubber layer 50 on an outer side of the second shell 20.

Further, the main control board 22 is further in conduction connection with a charging contact 221 used for charging the battery 21; and the charging contact 221 is arranged on a lower side surface of the second shell 20.

The massager of the present disclosure further includes a charging base 60. The charging base 60 is provided with a charging recess 61 with an upward opening; the charging recess 61 is matched with a lower side of the second rubber layer 50 (the handle portion), so that the massager can be stably placed on the charging base 60; and a bottom of the charging recess 61 is provided with a charging flicking needle 62 matched with the charging contact 221.

The key of the design of the present disclosure is as follows: Mainly by designing an intelligent start and stop massager, the massager can be automatically turned on when a user holds it; and the massager can be automatically turned off when the user releases it. The use convenience of the massager is further improved. Meanwhile, the first shell and the second shell are connected using the connecting spring, so that the first shell can move relative to the second shell, and the massage head can deform to be more in line with the human physiological curve; and the use comfort of the massager is improved.

The above descriptions are only preferred embodiments of the present disclosure, and do not limit the technical scope of the present disclosure. Therefore, any minor changes, equivalent changes and modifications made to the above embodiments according to the technical essence of the present disclosure still fall within the scope of the technical solutions of the present disclosure.

What is claimed is:

1. An intelligent start and stop massager, comprising a first shell, a connecting spring, and a second shell, wherein a lower end of the first shell is connected to an upper end of the second shell through the connecting spring;
a vibration motor is arranged in the first shell; the vibration motor is in driving connection with a deflection member; a battery, a main control board and a touch switch are arranged in the second shell;
the main control board is in conduction connection with the vibration motor, the battery and the touch switch;
a first rubber layer is wrapped on an outer side of the first shell; and a second rubber layer is wrapped on an outer side of the second shell.

2. The intelligent start and stop massager according to claim 1, wherein a movement clearance is kept between the lower end of the first shell and the upper end of the second shell.

3. The intelligent start and stop massager according to claim 1, wherein the first shell is provided with an upper end cover, and the upper end cover is light-transmittable;
a lamp panel which emits light towards the upper end cover is arranged in the first shell; and the main control board is in control connection with the lamp panel.

4. The intelligent start and stop massager according to claim 3, wherein the lamp panel is arranged on an upper side of the vibration motor.

5. The intelligent start and stop massager according to claim 1, wherein the touch switch is a touch sensor chip which is mounted on an inner side wall of the second shell.

6. The intelligent start and stop massager according to claim 5, wherein the touch sensor chip is a capacitive touch sensor chip or a resistive touch sensor chip.

7. The intelligent start and stop massager according to claim 5, wherein the touch sensor chip is a copper foil or an aluminum foil.

8. The intelligent start and stop massager according to claim 1, wherein a first fastening bulge is arranged on the second rubber layer; a first fastening slot matched with the first fastening bulge is formed in the first rubber layer; and during assembling, the first fastening bulge is located in the first fastening slot.

9. The intelligent start and stop massager according to claim 8, wherein a second fastening slot is arranged on the outer side of the first shell; and a second fastening bulge matched with the second fastening slot is arranged on the first rubber layer.

10. The intelligent start and stop massager according to claim 1, wherein the main control board is further in conduction connection with a charging contact used for charging the battery; and the charging contact is arranged on a lower side surface of the second shell.

11. The intelligent start and stop massager according to claim 10, further comprising a charging base, wherein the charging base is provided with a charging recess with an upward opening; the charging recess is matched with a lower side of the second rubber layer; and a bottom of the charging recess is provided with a charging flicking needle matched with the charging contact.

12. The intelligent start and stop massager according to claim 1, wherein the first shell and the second shell are both made of plastic.

13. The intelligent start and stop massager according to claim 1, wherein a friction indent is provided on an outer side surface of the second rubber layer, and the friction indent extends along an up-down direction.

14. The intelligent start and stop massager according to claim 1, wherein the main control board is arranged on a lower side of the battery, and the touch switch is arranged on a peripheral side of the battery.

15. The intelligent start and stop massager according to claim 1, wherein an upper end of the second rubber layer extends to and wraps a lower side of the first shell.
